(19) United States
(12) Patent Application Publication
(10) Pub. No.: US 2023/0282808 A1
(43) Pub. Date: Sep. 7, 2023

(54) LITHIUM PROTECTION COATINGS FOR LITHIUM-SULFUR BATTERIES AND METHODS OF FORMING THE SAME

(71) Applicant: GM GLOBAL TECHNOLOGY OPERATIONS LLC, Detroit, MI (US)

(72) Inventors: Sanaz KETABI, Rochester Hills, MI (US); Shuru CHEN, Troy, MI (US); Fang DAI, Troy, MI (US); Mei CAI, Bloomfield Hills, MI (US)

(73) Assignee: GM GLOBAL TECHNOLOGY OPERATIONS LLC, Detroit, MI (US)

(21) Appl. No.: 17/688,163

(22) Filed: Mar. 7, 2022

(51) Int. Cl. H01M 4/36; H01M 4/62; H01M 4/58; H01M 4/38

(52) U.S. Cl. CPC H01M 4/366; H01M 4/628; H01M 4/364; H01M 4/5825; H01M 4/382; H01M 4/5815; H01M 2004/021

(57) ABSTRACT

A method for forming a protective electrode coating on an electrode to be used in a lithium-sulfur battery is provided. The method includes contacting one or more surfaces of the electrode with a polymeric admixture, and polymerizing the polymeric admixture to form the protective electrode coating. The polymeric admixture includes a plurality of monomers, for example heterocyclic acetal monomers and/or cyclic ether monomers, and a lithium difluoro(oxalato)borate (LiDFOB) initiator. In certain instances, the polymeric admixture may also include a structural additive and/or a lithium salt. The contacting may include applying a thin film on the one or more surfaces of the electrode, and the polymerization may be heat activated.

### GOVERNMENT FUNDING

This invention was made with government support under Agreement No. DE-EE0008230 awarded by the U.S. Department of Energy. The Government may have certain rights in the invention.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, Hybrid Electric Vehicles (“HEVs”), and Electric Vehicles (“EVs”). Lithium-sulfur batteries can deliver high energy densities (e.g., up to about 2500 Wh/kg) and are generally available at lower costs and are environmentally friendly. In certain instances, however, lithium-sulfur batteries may have limited cell cycle lives and increased cell voltage hysteresis, for example, as a result of electrochemical reactions between dissolved polysulfides in liquid electrolyte and lithium metal anode. Accordingly, it would be desirable to develop materials and systems having both high energy densities and increased power capabilities.

### SUMMARY

This section provides a general summary of the disclosure, and is not a comprehensive disclosure of its full scope or all of its features.

The present disclosure relates to lithium-sulfur batteries, and more specifically, to lithium-sulfur batteries including lithium protection coatings (also referred to as a solid polymer electrolyte coatings) on one or more surfaces of negative electrodes, and to methods of making and using the same.

In various aspects, the present disclosure provides a method for forming a protective electrode coating on an electrode to be used in a lithium-sulfur battery. The method may include contacting one or more surfaces of the electrode with a polymeric admixture, and polymerizing the polymeric admixture to form the protective electrode coating. The polymeric admixture may include a plurality of monomers and a lithium difluoro(oxalato)borate (LiDFOB) initiator.

In one aspect, the polymeric admixture may include greater than or equal to about 50 wt. % to less than or equal to about 90 wt. % of the plurality of monomers, and greater than or equal to about 1 wt. % to less than or equal to about 10 wt. % of the lithium difluoro(oxalato)borate (LiDFOB) initiator.

In one aspect, the monomers of the plurality of monomers may include heterocyclic acetal monomers.

In one aspect, the heterocyclic acetal monomers may be selected from the group consisting of: 1,3-dioxolane (DOL), 1,3-dioxepane, 1,3,5-trioxane, and combinations thereof.

In one aspect, the polymeric admixture may further include greater than 0 wt. % to less than or equal to about 30 wt. % of a structural additive.

In one aspect, the structural additive may be selected from the group consisting of: epoxides, methacrylates, dimethacrylates, and combinations thereof.

In one aspect, the polymeric admixture may further include greater than or equal to about 5 wt. % to less than or equal to about 50 wt. % of a lithium salt.

In one aspect, the lithium salt may be selected from the group consisting of: lithium bis(trifluoromethanesulfonyl)imide (LiTFSI), lithium bis(fluorosulfonyl)imide (LiFSI), lithium tetrafluoroborate (LiBF₄), and combinations thereof.

In one aspect, the contacting may include disposing a thin film that includes the polymeric admixture on or near the one or more surfaces of the electrode.

In one aspect, the thin film may have a thickness greater than or equal to about 5 μm to less than or equal to about 10 μm.

In one aspect, the thin film may be disposed on or near the one or more surfaces of the electrode by using a doctor blade process.

In one aspect, the polymerizing may include applying heat to the polymeric admixture. The applied heat may be greater than or equal to about 40° C. to less than or equal to about 100° C.

In one aspect, the electrode may include lithium metal.

In various aspects, the present disclosure provides a method for forming a protective electrode coating on an electrode to be used in a lithium-sulfur battery. The method may include forming a thin film precursor on or near one or more surfaces of the electrode, and polymerizing the polymeric admixture to form the protective electrode coating. The thin film precursor includes a polymeric admixture, and the polymeric admixture may include a plurality of monomers and a lithium difluoro(oxalato)borate (LiDFOB) initiator. The thin film precursor may have a thickness greater than or equal to about 5 μm to less than or equal to about 10 μm.

In one aspect, the polymeric admixture may include greater than or equal to about 50 wt. % to less than or equal to about 90 wt. % of the plurality of monomers, and greater than or equal to about 1 wt. % to less than or equal to about 10 wt. % of the lithium difluoro(oxalato)borate (LiDFOB) initiator.

In one aspect, the monomers of the plurality of monomers may be heterocyclic acetal monomers, cyclic ether monomers, or a combination of heterocyclic acetal monomers and cyclic ether monomers.

In one aspect, the polymeric admixture may further include greater than 0 wt. % to less than or equal to about 30 wt. % of a structural additive. The structural additive may be selected from the group consisting of: epoxides, methacrylates, dimethacrylates, and combinations thereof.

In one aspect, the polymeric admixture may further include greater than or equal to about 5 wt. % to less than or equal to about 50 wt. % of a lithium salt. The lithium salt may be selected from the group consisting of: lithium bis(trifluoromethanesulfonyl)imide (LiTFSI), lithium bis(fluorosulfonyl)imide (LiFSI), lithium tetrafluoroborate (LiBF₄), and combinations thereof.

In one aspect, the polymerizing may include applying heat to the polymeric admixture. The applied heat may be greater than or equal to about 40° C. to less than or equal to about 100° C.

In various aspects, the present disclosure provides a lithium-sulfur battery. The lithium-sulfur battery includes a positive electrode and a negative electrode. The positive electrode may include a positive electroactive material including sulfur. The negative electrode may include a negative electroactive material layer that includes lithium metal, and a protective coating disposed over the negative electroactive material layer. The protective coating may have a thickness greater than or equal to about 5 μm to less than or equal to about 10 μm. The protective coating may be formed by cationic ring-opening polymerization of heterocyclic acetal monomers, cyclic ether monomers, or a combination of heterocyclic acetal monomers and cyclic ether monomers. The cationic ring-opening polymerization may be initiated by lithium difluoro(oxalato)borate (LiDFOB).

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic illustration of an example electrochemical battery cell including an electrode having a protective layer in accordance with various aspects of the present disclosure;

FIG. 2 is a flowchart illustrating an example method for preparing a protective layer on one or more surfaces of an electrode in accordance with various aspects of the present disclosure;

FIG. 3A is a graphical illustration demonstrating charge/discharge profiles of different cycles of the example battery prepared in accordance with various aspects of the present disclosure;

FIG. 3B is a graphical illustration demonstrating charge/discharge profiles of different cycles of a comparative battery; and

FIG. 3C is a graphical illustration demonstrating capacity retention and Coulombic efficiency of an example battery prepared in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

A typical lithium-sulfur battery includes a first electrode (such as a positive electrode or cathode) opposing a second electrode (such as a negative electrode or anode) and a separator and/or electrolyte disposed therebetween. Often, in a lithium-sulfur battery pack, batteries or cells may be electrically connected in a stack or winding configuration to increase overall output. Lithium-sulfur batteries operate by reversibly passing lithium ions between the first and second electrodes. For example, lithium ions may move from a positive electrode (or cathode) to a negative electrode (or anode) during charging of the battery, and in the opposite direction when discharging the battery. More specifically, during discharge, lithium ions migrate from and through an electrolyte to the positive electrode, where the sulfur is reduced to lithium sulfide (Li₂S). The lithium sulfide (Li₂S) is re-oxidized to sulfur during the recharge phase. On anode side, lithium dissolution from the anode surface (and incorporation into lithium polysulfide salts) occurs during discharge, and reverse lithium plating on the anode occurs during charging. The electrolyte is suitable for conducting lithium ions and may be in liquid, gel, or solid form.

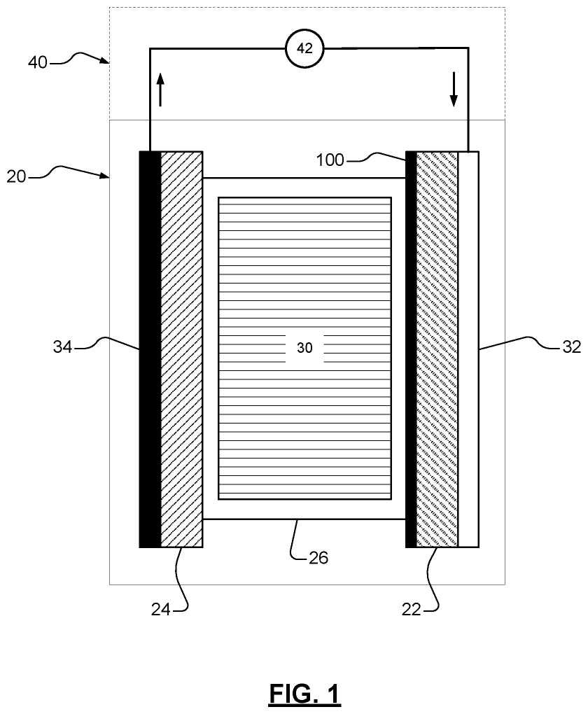

An exemplary and schematic illustration of an electrochemical cell (also referred to as the battery) 20 is shown in FIG. 1. Such cells are used in vehicle or automotive transportation applications (e.g., motorcycles, boats, tractors, buses, motorcycles, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples include a single positive electrode cathode and a single anode, the skilled artisan will recognize that the present teachings extend to various other configurations, including those having one or more cathodes and one or more anodes, as well as various current collectors with electroactive layers disposed on or adjacent to one or more surfaces thereof.

The battery 20 includes a negative electrode 22 (e.g., anode), a positive electrode 24 (e.g., cathode), and a separator 26 disposed between the two electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and positive electrode 24. In certain variations, the separator 26 may be formed by a solid-state electrolyte or a semi-solid-state electrolyte (e.g., gel electrolyte). For example, the separator 26 may be defined by a plurality of solid-state electrolyte particles (not shown). In the instance of solid-state batteries and/or semi-solid-state batteries, the positive electrode 24 and/or the negative electrode 22 may include a plurality of solid-state electrolyte particles (not shown). The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode 22. The first current collector 32 may be a metal foil, metal grid or screen, or expanded metal comprising copper or any other appropriate electronically conductive material known to those of skill in the art. A second current collector 34 (e.g., a positive current collector) may be positioned at or near the positive electrode 24. The second electrode current collector 34 may be a metal foil, metal grid or screen, or expanded metal comprising aluminum or any other appropriate electronically conductive material known to those of skill in the art. The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34).

The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of lithium metal, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form lithium polysulfides and lithium sulfide at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the battery 20 to reverse the electrochemical reactions that occur during battery discharge. Connecting an external electrical energy source to the battery 20 promotes a reaction, for example, non-spontaneous oxidation of lithium polysulfides and lithium sulfide, at the positive electrode 24 so that electrons and lithium ions are produced. The lithium ions flow back toward the negative electrode 22 through the electrolyte 30 across the separator 26 to deposit lithium metal on the negative electrode 22 for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. For example, in certain aspects, the electrolyte 30 may be a non-aqueous liquid electrolyte solution (e.g.,>1M) that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis (oxalato)borate (LiB (C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiFSI), and combinations thereof. These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran, 1,3-dioxolane), sulfur compounds (e.g., sulfolane), and combinations thereof.

In various aspects, the separator 26 may be a microporous polymeric separator. The microporous polymeric separator may include, for example, a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of polyethylene (PE) and/or polypropylene (PP). Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 μm to less than or equal to about 50 μm, and in certain instances, optionally greater than or equal to about 1 μm to less than or equal to about 20 μm. The separator 26 may have an average thickness greater than or equal to 1 μm to less than or equal to 50 μm, and in certain instances, optionally greater than or equal to 1 μm to less than or equal to 20 μm.

In each variation, the separator 26 may further include one or more ceramic materials and/or one or more heat-resistant materials. For example, the separator 26 may also be admixed with the one or more ceramic materials and/or the one or more heat-resistant materials, or one or more surfaces of the separator 26 may be coated with the one or more ceramic materials and/or the one or more heat-resistant materials. The one or more ceramic materials may include, for example, alumina (Al₂O₃), silica (SiO₂), and the like. The heat-resistant material may include, for example, Nomex, Aramid, and the like.

In various aspects, the porous separator 26 and/or the electrolyte 30 disposed in the porous separator 26 as illustrated in FIG. 1 may be replaced with a solid-state electrolyte (“SSE”) layer (not shown) and/or semi-solid-state electrolyte (e.g., gel) layer that functions as both an electrolyte and a separator. The solid-state electrolyte layer and/or semi-solid-state electrolyte layer may be disposed between the positive electrode 24 and negative electrode 22. The solid-state electrolyte layer and/or semi-solid-state electrolyte layer facilitates transfer of lithium ions, while mechanically separating and providing electrical insulation between the negative and positive electrodes 22, 24. By way of non-limiting example, the solid-state electrolyte layer and/or semi-solid-state electrolyte layer may include a plurality of solid-state electrolyte particles, such as LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S-P₂S₅, Li₆PS₅Cl, Li₆PS₅Br, Li₆PS₅I, Li₃OCl, Li_{2.99} Ba_{0.005}ClO, or combinations thereof.

The positive electrode 24 may be formed from a sulfur-based electroactive material that is capable of undergoing lithium intercalation and deintercalation, alloying and dealloying, or plating and stripping, while functioning as the positive terminal of the battery 20. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores (not shown) of the positive electrode 24. For example, in certain variations, the positive electrode 24 may include a plurality of solid-state electrolyte particles (not shown). In each instance, the positive electrode 24 may have a thickness greater than or equal to about 1 μm to less than or equal to about 500 μm, and in certain aspects, optionally greater than or equal to about 10 μm to less than or equal to about 200 μm. The positive electrode 24 may have a thickness greater than or equal to 1 μm to less than or equal to 500 μm, and in certain aspects, optionally greater than or equal to 10 μm to less than or equal to 200 μm.

In various aspects, the positive electrode 24 includes a sulfur-containing electroactive material and a sulfur host material. For example, in certain variations, the positive electrode 24 may include greater than or equal to about 20 wt. % to less than or equal to about 98 wt. %, and in certain aspects, optionally greater than or equal to about 60 wt. % to less than or equal to about 90 wt. %, of the sulfur-containing electroactive material, and greater than or equal to about 2 wt. % to less than or equal to about 60 wt. %, and in certain aspects, optionally greater than or equal to about 10 wt. % to less than or equal to about 30 wt. %, of the sulfur host material. In other variations, the positive electrode 24 may include greater than or equal to 20 wt. % to less than or equal to 98 wt. %, and in certain aspects, optionally greater than or equal to 60 wt. % to less than or equal to 90 wt. %, of the sulfur-containing electroactive material, and greater than or equal to 2 wt. % to less than or equal to 60 wt. %, and in certain aspects, optionally greater than or equal to 10 wt. % to less than or equal to 30 wt. %, of the sulfur host material.

In certain variations, the sulfur host material may be a carbon-based host, including, for example only, carbon nanotubes, amorphous carbon (e.g., carbon black, such as KETJENBLACK®), porous carbon, carbon nanofibers, carbon spheres, carbon nanocage, graphene, graphene oxide, reduced graphene oxide, doped carbon (e.g., N-doped carbon nanotubes), and hybrids and the like. In other variations, the sulfur host material may be a conducting polymer-based host, including, for example only, polyaniline (PAN), polypyrrole (PPy), polythiophene (Pt), polyaniline (PAni), poly (3,4-ethylenedioxythiophene:poly (styrenesulfonate) (PEDOT: PSS), and the like. In further variations, the sulfur host material may be a metal oxide-base host including, for example only, TiO₂, SiO₂, CoS₂, Ti₄O₇, CeO₂, MoO₃, V₂O₅, SnO₂, and the like; a metal sulfide-based host including, for example only, Ni₃S₂, MoS₂, FeS, VS₂, TiS₂, TiS, CoS₂, Co₉S₈, NbS, and the like; a metal nitride-based host including, for example only, VN, TiN, Ni₂N, CrN, ZrN, NbN, and the like; metal carbide-based host including, for example only, TiC, Ti₂C, B₄C, and the like; metal organic framework (MOF)-based host including, for example only, Ni-based-MOFs, Ce-based-MOFs, and the like; and hybrids or combinations thereof (e.g., polypyrrole/graphene, vanadium nitride/graphene, and the like). In still further variations, the sulfur host material may include MgB₂, TiCl₂, phosphorene, C₃B, Li₄Ti₅O₁₂, and the like. Such sulfur host materials may enhance electron transfer at the sulfur/host interface, accommodate volumetric changes within the battery 20, minimize polysulfide shuttles, and/or promote conversions among polysulfide intermediates. As would be recognized by the skilled artisan, the polysulfide shuttle effect may be caused by the dissolution of intermediate lithium polysulfide species in the electrolyte 30 causing, for example, corrosion of the lithium-containing negative electrode and/or irreversible loss of active sulfur, each of which can result in rapid capacity fading and poor Coulombic efficiency of the battery 20.

In various aspects, the sulfur-containing electroactive material and a sulfur host material in the positive electrode 24 may be optionally intermingled with one or more electronically conductive materials that provide an electron conductive path and/or at least one polymeric binder material that improves the structural integrity of the positive electrode 24. For example, the positive electroactive material in the positive electrode 24 may be optionally intermingled (e.g., slurry cast) with binders like polyimide, polyamic acid, polyamide, polysulfone, polyvinylidene difluoride (PVdF), polyvinylidene difluoride (PVdF) copolymers, polytetrafluoroethylene (PTFE), polytetrafluoroethylene (PTFE) copolymers, polyacrylic acid, blends of polyvinylidene fluoride and polyhexafluoropropene, polychlorotrifluoroethylene, ethylene propylene diene monomer (EPDM) rubber, carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. Electronically conducting materials may include carbon-based materials, powdered nickel or other metal particles, or a conductive polymer. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like. In certain aspects, mixtures of the conductive materials may be used.

In various aspects, the positive electrode 24 may include greater than or equal to 0 wt. % to less than or equal to about 40 wt. %, optionally greater than or equal to about 0.5 wt. % to less than or equal to about 20 wt. %, and in certain aspects, optionally greater than or equal to about 0.5 wt. % to less than or equal to about 5 wt. %, of the electronically conducting material; and greater than or equal to 0 wt. % to less than or equal to about 40 wt. %, optionally greater than or equal to about 0.5 wt. % to less than or equal to about 20 wt. %, and in certain aspects, optionally greater than or equal to about 0.5 wt. % to less than or equal to about 9 wt. %, of the at least one polymeric binder.

In certain variations, the positive electrode 24 may include greater than or equal to 0 wt. % to less than or equal to 40 wt. %, optionally greater than or equal to 0.5 wt. % to less than or equal to 20 wt. %, and in certain aspects, optionally greater than or equal to 0.5 wt. % to less than or equal to 5 wt. %, of the electronically conducting material; and greater than or equal to 0 wt. % to less than or equal to 40 wt. %, optionally greater than or equal to 0.5 wt. % to less than or equal to 20 wt. %, and in certain aspects, optionally greater than or equal to 0.5 wt. % to less than or equal to 9 wt. %, of the at least one polymeric binder.

The negative electrode 22 may be formed from a lithium host material that is capable of functioning as a negative terminal of the battery 20. In various aspects, the negative electrode 22 may be defined by a plurality of negative electroactive material particles (not shown). Such negative electroactive material particles may be disposed in one or more layers so as to define the three-dimensional structure of the negative electrode 22. The electrolyte 30 may be introduced, for example after cell assembly, and contained within pores (not shown) of the negative electrode 22. In certain variations, the negative electrode 22 may include a plurality of solid-state electrolyte particles (not shown). The negative electrode 22 may have an average thickness greater than or equal to about 1 μm to less than or equal to about 500 μm, and in certain aspects, optionally greater than or equal to about 10 μm to less than or equal to about 200 μm. The negative electrode 22 may have an average thickness greater than or equal to 1 μm to less than or equal to 500 μm, and in certain aspects, optionally greater than or equal to 10 μm to less than or equal to 200 μm.

In various aspects, the negative electroactive material may include lithium, for example, a lithium alloy (e.g., lithium silicon, lithium tin, and the like) and/or a lithium metal. For example, in certain variations, the negative electrode 22 may be defined by a lithium metal foil. The lithium metal foil may have an average thickness greater than or equal to about 0 nm to less than or equal to about 500 μm, and in certain aspects, optionally greater than or equal to about 50 nm to less than or equal to about 50 μm. The lithium metal foil may have an average thickness greater than or equal to 0 nm to less than or equal to 500 μm, and in certain aspects, optionally greater than or equal to 50 nm to less than or equal to 50 μm.

In other variations, the negative electroactive material may include, for example only, carbonaceous materials (such as, graphite, hard carbon, soft carbon, and the like) and metallic active materials (such as tin, aluminum, magnesium, germanium, and alloys thereof, and the like). In still other variations, the negative electroactive material may be a silicon-based electroactive material, and in further variations, the negative electroactive material may include a combination of the silicon-based electroactive material (i.e., first negative electroactive material) and one or more other negative electroactive materials. The one or more other negative electroactive materials include, for example only, carbonaceous materials (such as, graphite, hard carbon, soft carbon, and the like) and metallic active materials (such as tin, aluminum, magnesium, germanium, and alloys thereof, and the like). For example, in certain variations, the negative electroactive material may include a carbonaceous-silicon based composite including, for example, about 10 wt. % of a silicon-based electroactive material and about 90 wt. % graphite. The negative electroactive material may include a carbonaceous-silicon based composite including, for example, 10 wt. % of a silicon-based electroactive material and 90 wt. % graphite.

In certain variations, for example, when the negative electrode includes carbonaceous and/or silicon-based electroactive materials, the negative electroactive material(s) in the negative electrode 22 may be optionally intermingled with one or more electrically conductive materials that provide an electron conductive path and/or at least one polymeric binder material that improves the structural integrity of the negative electrode 22. For example, the negative electroactive material(s) in the negative electrode 22 may be optionally intermingled (e.g., slurry casted) with binders like polyimide, polyamic acid, polyamide, polysulfone, polyvinylidene difluoride (PVdF), polytetrafluoroethylene (PTFE,), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. Electrically conducting materials may include carbon-based materials, powdered nickel or other metal particles, or a conductive polymer. Carbon-based materials may include, for example, particles of graphite, acetylene black (such as KETCHEN™ black or DENKA™ black), carbon fibers and nanotubes, graphene, and the like. Examples of a conductive polymer include polyaniline, polythiophene, polyacetylene, polypyrrole, and the like. In certain aspects, mixtures of the conductive materials may be used.

In various aspects, the negative electrode 22 may include greater than or equal to about 10 wt. % to less than or equal to about 99 wt. %, and in certain aspects, optionally greater than or equal to about 60 wt. % to less than or equal to about 99 wt. %, of the negative electroactive material; greater than or equal to 0 wt. % to less than or equal to about 40 wt. %, and in certain aspects, optionally greater than or equal to about 0.5 wt. % to less than or equal to about 20 wt. %, of the electronically conducting material; and greater than or equal to 0 wt. % to less than or equal to about 40 wt. %, and in certain aspects, optionally greater than or equal to about 0.5 wt. % to less than or equal to about 20 wt. %, of the at least one polymeric binder.

In certain variations, the negative electrode 22 may include greater than or equal to 10 wt. % to less than or equal to 99 wt. %, and in certain aspects, optionally greater than or equal to 60 wt. % to less than or equal to 99 wt. %, of the negative electroactive material; greater than or equal to 0 wt. % to less than or equal to 40 wt. %, and in certain aspects, optionally greater than or equal to 0.5 wt. % to less than or equal to 20 wt. %, of the electronically conducting material; and greater than or equal to 0 wt. % to less than or equal to 40 wt. %, and in certain aspects, optionally greater than or equal to 0.5 wt. % to less than or equal to 20 wt. %, of the at least one polymeric binder.

The battery 20 further includes one or more protective layers disposed on or adjacent to one or more surfaces of the negative electrode 22. For example, as illustrated, the battery 20 may include a protective layer (also referred to as a lithium protection coating) 100 disposed between the negative electrode 22 and the separator 26 (or solid-state electrolyte in the instance of solid-state or semi-solid state batteries). The protective layer 100 is configured to protect the negative electrode 22 from certain side reactions with the electrolyte 30, and also, polysulfides. In various aspects, the protective layer 100 may also be referred to as a solid-state electrolyte (SEE) layer and/or solid polymer electrolyte coating because, as further detailed below, the protective layer 100 includes a lithium salt in a solid polymer and is capable of conducting lithium ions.

In each variation, the protective layer 100 is a polymeric matrix layer prepared by cationic ring-opening polymerization of heterocyclic acetal monomers (e.g., 1,3-dioxolane (DOL), 1,3-dioxepane, 1,3,5-trioxane, and the like). By way of non-limiting example, the cationic ring-opening polymerization of 1,3-dioxolane (DOL) may be generally represented as follows:

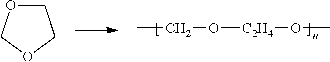

The cationic ring-opening polymerization of 1,3,5-trioxane may be generally represented as follows:

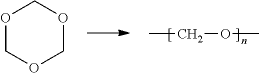

In each instance, the cationic ring-opening polymerization may be initiated using a mild initiator. For example, in certain variations, the initiator may be lithium difluoro(oxalato)borate (LiDFOB). As would be recognized by the skilled artisan, mild initiators are those that initiate a polymerization only after a certain period of time and/or after exposure to certain temperatures. In contrast, strong initiators initiate polymerization of monomers upon contact.

The protective layer 100 further includes one or more lithium salts disposed within the polymeric matrix, such that lithium ions are able to pass through the protective layer 100 and deposit or dissolve during charge or discharge without adding substantial resistance to the battery 20. The polymeric layer may include greater than or equal to about 5 wt. % to less than or equal to about 50 wt. %, and in certain aspects, optionally greater than or equal to 5 wt. % to less than or equal to 50 wt. %, of the lithium salt. The lithium salt may be selected from the group consisting of: lithium bis(trifluoromethanesulfonyl)imide (LiTFSI), lithium bis(fluorosulfonyl)imide (LiFSI), lithium tetrafluoroborate (LiBF₄), and combinations thereof.

In still further variations, one or more structural additives may be polymerized with the heterocyclic acetal monomers. For example, the polymeric layer may include greater than or equal to about 5 wt. % to less than or equal to about 30 wt. %, and in certain aspects, optionally greater than or equal to 5 wt. % to less than or equal to 30 wt. %, of the one or more structural additives. The structural additive may be selected from epoxides (such as, trimethylolpropane triglycidyl ether (TMPTGE)), methacrylates (such as, poly(ethylene glycol) methyl ether methacrylate (PEGMA)), and dimethacrylates (such as, poly(ethylene glycol) dimethacrylate (PEGDMA)), and combinations thereof.

In each variation, the protective layer 100 may have a thickness greater than or equal to about 5 μm to less than or equal to about 10 μm, and in certain aspects, optionally greater than or equal to 5 μm to less than or equal to 10 μm. The protective layer 100 may retard the diffusion of polysulfides and impede side reactions between the negative electrode 22 (e.g., lithium metal) and polysulfides. In certain variations, the protective layer 100 may serve as the electrolyte for the negative electrode 22, such the battery 20 has a dual-phase electrolyte configuration (i.e., the positive electrode including electrolyte 30 and the negative electrode including the protective layer 100) that enables liquid-solid two-phase reactions of sulfur and soluble polysulfide intermediate species.

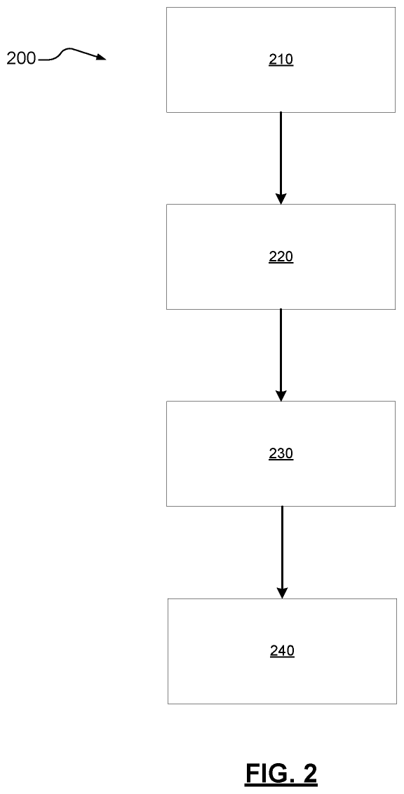

In various aspects, the present disclosure provides methods for preparing a protective layer on one or more surfaces of a negative electrode, like the protective layer 100 illustrated in FIG. 1. In certain instances, the protective layer may be prepared ex-situ, for example, FIG. 2 illustrates an example method 200 for preparing a protective layer that includes contacting 220 a polymeric admixture to one or more surfaces of the negative electrode. In certain variations, the polymeric admixture may be disposed on or near the one or more surfaces of the negative electrode. For example, the polymeric admixture may be disposed as a thin film (e.g., greater than or equal to about 5 μm to less than or equal to about 10 μm, and in certain aspects, optionally greater than or equal to 5 μm to less than or equal to 10 μm) on or near the one or more surfaces of the negative electrode using a blade coating method (e.g., doctor blade coating method).

In each instance, the polymeric admixture may include heterocyclic acetal monomers (e.g., 1,3-dioxolane (DOL), 1,3-dioxepane, 1,3,5-trioxane, and the like) and an initiator. The initiator may be a mild initiator, like lithium difluoro(oxalato)borate (LiDFOB). In certain variations, the polymeric admixture may further include one or more structural additives (e. g., epoxides (such as, trimethylolpropane triglycidyl ether (TMPTGE)), methacrylates (such as, poly(ethylene glycol) methyl ether methacrylate (PEGMA)), and dimethacrylates (such as, poly(ethylene glycol) dimethacrylate (PEGDMA))) and/or one or more salts (e.g., lithium bis(trifluoromethanesulfonyl)imide (LiTFSI), lithium bis(fluorosulfonyl)imide (LiFSI), lithium tetrafluoroborate (LiBF₄), and the like).

For example, the polymeric admixture may include greater than or equal to about 50 wt. % to less than or equal to about 90 wt. %, and in certain aspects, optionally greater than or equal to 50 wt. % to less than or equal to 90 wt. %, of the monomer(s); greater than or equal to about 1 wt. % to less than or equal to about 10 wt. %, and in certain aspects, optionally greater than or equal to 1 wt. % to less than or equal to 10 wt. %, of the initiator; greater than or equal to about 0 wt. % to less than or equal to about 30 wt. %, and in certain aspects, optionally greater than or equal to 0 wt. % to less than or equal to 30 wt. %, of the one or more structural additives; and greater than or equal to about 5 wt. % to less than or equal to about 50 wt. %, and in certain aspects, optionally greater than or equal to 5 wt. % to less than or equal to 50 wt. %, of the one or more salts.

In various aspects, the method 200 may further include preparing 210 the polymeric admixture. Although not illustrated, the skilled artisan will understand that preparing 210 the polymeric admixture may include one or more additional or contacting steps. In each variation, the polymeric admixture may be polymerized 230 to form the protective layer. Although illustrated as a separate method step in FIG. 2, the skilled artisan will understand that polymerization may occur as the initiator is contacted with the one or more monomers (e., the heterocyclic acetal monomer(s) and/or the cyclic ether monomer(s)). Polymerization may be controlled by adjusting the composition of the polymeric admixture and/or applying a temperature to the as-disposed polymeric admixture. For example, the polymeric admixture and the negative electrode may be heated in an oven having a temperature greater than or equal to about 40° C. to less than or equal to about 100° C., and in certain aspects, optionally greater than or equal to 40° C. to less than or equal to 100° C.

In certain variations, the method 200 may further include preparing 340 an electrochemical cell (like the battery 20 illustrated in FIG. 1) including the negative electrode, which has the one or more protective coatings.

Although not illustrated, the skilled artisan will understand that in various aspects the protective layer may be prepared in-situ. For example, a polymeric admixture, like that detailed above may be disposed on one or more surfaces of a negative electrode, and polymerization may occur during cell operation.

Certain features of the current technology are further illustrated in the following non-limiting examples.

### Example 1

Example battery cells may be prepared in accordance with various aspects of the present disclosure.

For example, an example battery cell 310 may include a negative electrode prepared in accordance with various aspects of the present disclosure. The negative electrode may include, for example, one or more protective coatings prepared by cationic ring-opening polymerization of heterocyclic acetal monomers (e.g., 1,3-dioxolane (DOL), 1,3-dioxepane, 1,3,5-trioxane, and the like), as detailed above. A comparative battery cell 320 may include the negative electrode without the one or more protective coatings.

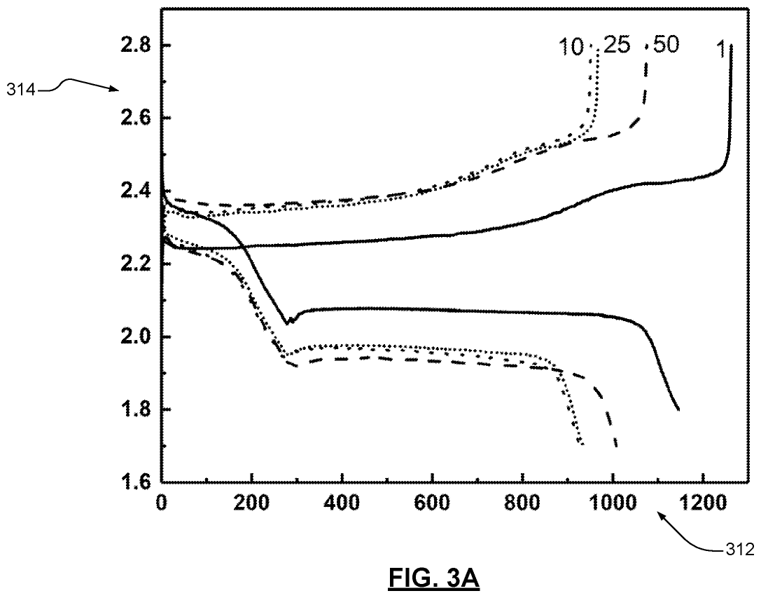

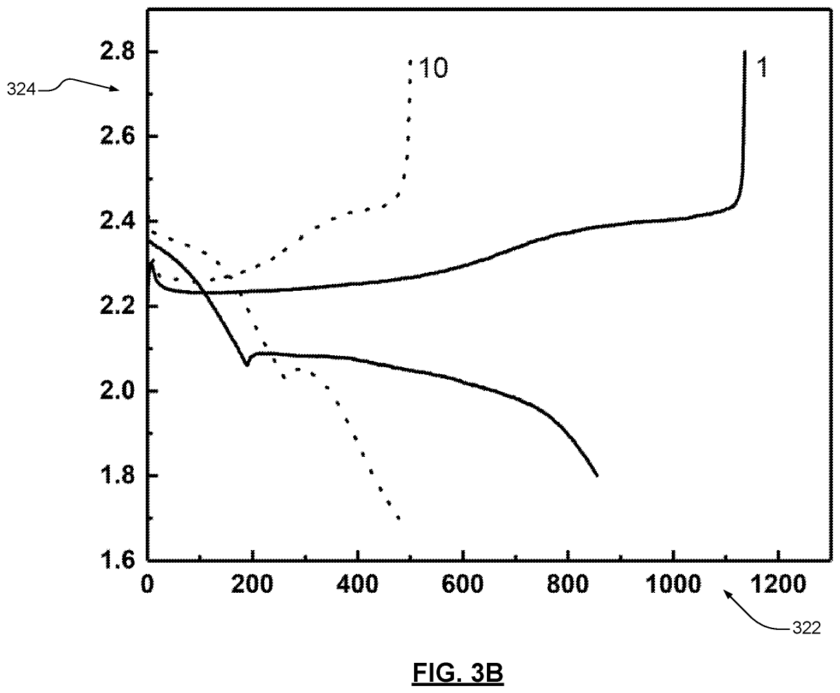

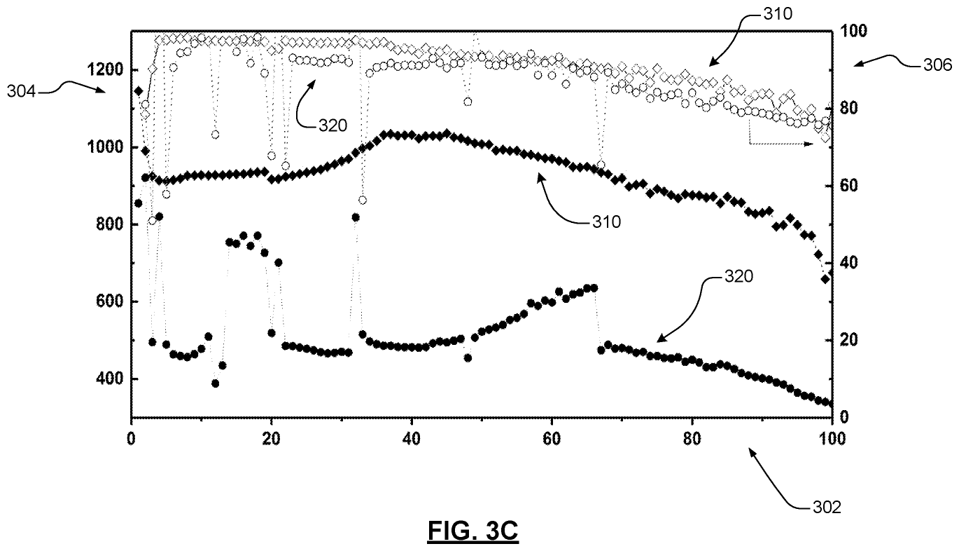

FIG. 3A is a graphical illustration demonstrating the capacity retention of the example battery 310, where the x-axis 312 represents capacity (mAh·g^{31 1}) and the y-axis 314 represents voltage (V) and the numerals 10, 25, 50, 1 represent cycle number. FIG. 3B is a graphical illustration demonstrating capacity retention of the comparative battery 320, where the x-axis 322 represents capacity (mAh·g⁻¹) and the y-axis 324 represents voltage (V) and the numbers 10, 1 represent cycle number. FIG. 3C is a graphical illustration demonstrating capacity retention and Coulombic efficiency of the example battery 310 as compared to the comparative battery 320, where the x-axis 302 represents cycle number, the y₁-axis 304 represents capacity (mAh·g⁻¹), and the y₂-axis 306 represents Coulombic efficiency (%). As illustrated, the example battery 310 has improved capacity retention and cycle life.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for forming a protective electrode coating on an electrode to be used in a lithium-sulfur battery, the method comprising:
contacting one or more surfaces of the electrode with a polymeric admixture, wherein the polymeric admixture comprises a plurality of monomers and a lithium difluoro(oxalato)borate (LiDFOB) initiator; and
polymerizing the polymeric admixture to form the protective electrode coating.

2. The method of claim 1, wherein the polymeric admixture comprises:
greater than or equal to about 50 wt. % to less than or equal to about 90 wt. % of the plurality of monomers; and
greater than or equal to about 1 wt. % to less than or equal to about 10 wt. % of the lithium difluoro(oxalato)borate (LiDFOB) initiator.

3. The method of claim 1, wherein the monomers of the plurality of monomers comprises heterocyclic acetal monomers.

4. The method of claim 3, wherein the heterocyclic acetal monomers are selected from the group consisting of: 1,3-dioxolane (DOL), 1,3-dioxepane, 1,3,5-trioxane, and combinations thereof.

5. The method of claim 1, wherein the polymeric admixture further comprises:
greater than 0 wt. % to less than or equal to about 30 wt. % of a structural additive.

6. The method of claim 5, wherein the structural additive is selected from the group consisting of: epoxides, methacrylates, dimethacrylates, and combinations thereof.

7. The method of claim 1, wherein the polymeric admixture further comprises:
greater than or equal to about 5 wt. % to less than or equal to about 50 wt. % of a lithium salt.

8. The method of claim 7, wherein the lithium salt is selected from the group consisting of: lithium bis(trifluoromethanesulfonyl)imide (LiTFSI), lithium bis(fluorosulfonyl)imide (LiFSI), lithium tetrafluoroborate (LiBF₄), and combinations thereof.

9. The method of claim 1, wherein the contacting comprises:
disposing a thin film comprising the polymeric admixture on or near the one or more surfaces of the electrode.

10. The method of claim 9, wherein the thin film has a thickness greater than or equal to about 5 μm to less than or equal to about 10 μm.

11. The method of claim 9, wherein the thin film is disposed on or near the one or more surfaces of the electrode by using a doctor blade process.

12. The method of claim 1, wherein the polymerizing comprises:
applying heat to the polymeric admixture, wherein the applied heat is greater than or equal to about 40° C. to less than or equal to about 100° C.

13. The method of claim 1, wherein the electrode comprises lithium metal.

14. A method for forming a protective electrode coating on an electrode to be used in a lithium-sulfur battery, the method comprising:
forming a thin film precursor on or near one or more surfaces of the electrode, the thin film precursor comprising a polymeric admixture, the polymeric admixture comprising a plurality of monomers and a lithium difluoro(oxalato)borate (LiDFOB) initiator, and the thin film precursor having a thickness greater than or equal to about 5 μm to less than or equal to about 10 μm; and
polymerizing the polymeric admixture to form the protective electrode coating.

15. The method of claim 14, wherein the polymeric admixture comprises:
greater than or equal to about 50 wt. % to less than or equal to about 90 wt. % of the plurality of monomers; and
greater than or equal to about 1 wt. % to less than or equal to about 10 wt. % of the lithium difluoro(oxalato)borate (LiDFOB) initiator.

16. The method of claim 14, wherein the monomers of the plurality of monomers are heterocyclic acetal monomers, cyclic ether monomers, or a combination of heterocyclic acetal monomers and cyclic ether monomers.

17. The method of claim 14, wherein the polymeric admixture further comprises:
greater than 0 wt. % to less than or equal to about 30 wt. % of a structural additive, wherein the structural additive is selected from the group consisting of:
epoxides, methacrylates, dimethacrylates, and combinations thereof.

18. The method of claim 14, wherein the polymeric admixture further comprises:
greater than or equal to about 5 wt. % to less than or equal to about 50 wt. % of a lithium salt, wherein the lithium salt is selected from the group consisting of: lithium bis(trifluoromethanesulfonyl)imide (LiTFSI), lithium bis(fluorosulfonyl)imide (LiFSI), lithium tetrafluoroborate (LiBF₄), and combinations thereof.

19. The method of claim 14, wherein the polymerizing comprises:
applying heat to the polymeric admixture, wherein the applied heat is greater than or equal to about 40° C. to less than or equal to about 100° C.

20. A lithium-sulfur battery comprising:
a positive electrode comprising a positive electroactive material comprising sulfur;
a negative electrode comprising:
a negative electroactive material layer comprising lithium metal; and
a protective coating disposed over the negative electroactive material layer having a thickness greater than or equal to about 5 μm to less than or equal to about 10 μm, wherein the protective coating is formed by cationic ring-opening polymerization of heterocyclic acetal monomers, cyclic ether monomers, or a combination of heterocyclic acetal monomers and cyclic ether monomers, wherein the cationic ring-opening polymerization is initiated by lithium difluoro(oxalato)borate (LiDFOB).
